(19) United States
(12) Patent Application Publication
(10) Pub. No.: US 2006/0066272 A1
(43) Pub. Date: Mar. 30, 2006

(54) Control device for three phase ac generator-motor

(75) Inventors: Tadashi Yamazaki, Tsurugashima-shi (JP); Junichi Takahashi, Tsurugashima-shi (JP)

Correspondence Address: FULBRIGHT AND JAWORSKI LLP, 555 S. FLOWER STREET, 41ST FLOOR, LOS ANGELES, CA, 90071, US

(73) Assignee: Toyo Denso Kabushiki Kaisha

(21) Appl. No.: 10/953,720

(22) Filed: Sep. 28, 2004

(51) Int. Cl. H02P 5/20

(52) U.S. Cl. 318/140

(57) ABSTRACT

A control device of a three-phase alternating current motor-generator, which works as an inverter circuit for driving the motor-generator as a motor by using a battery and also functions as a three-phase rectifier circuit for driving the motor-generator as a generator for producing output power for charging a battery. The control circuit uses MOS field-effect transistors as control elements for respective phases. When the motor-generator is driven as the three-phase ac generator, the control device uses means for conducting synchronous rectification by using MOSFETs only on the negative potential side for respective phases. This can simplify the rectifying operation, reduce the rectification loss and improve the battery charging efficiency.

### BACKGROUND OF THE INVENTION

The present invention relates to a control device for three-phase alternating-current motor-generator, which conducts the current carrying control of a circuit which works as a three-phase inverter circuit for driving the motor generator as a three-phase alternating-current motor by using a battery and also works as a three-phase rectifier circuit for driving the motor-generator as a three-phase alternating-current generator for charging the battery.

In general, a three-phase ac motor-generator is mounted in a vehicle to work as a three-phase ac motor with a battery power supply through a three-phase ac inverter circuit when starting an engine of the vehicle and to work as a three-phase ac generator for charging the battery through a three-phase rectifier circuit after starting the engine.

Recently, there has been developed a control circuit which functions as a three-phase inverter circuit for driving the three-phase ac motor-generator as a motor and also works as a three-phase ac rectifier for driving the motor-generator as a generator for charging the battery and which is featured, as shown in FIG. 1, by using MOS field-effect transistors MOSFET 1 to 6 as control elements for respective phases U, V and W in the circuit. In FIG. 1, M/G designates a three-phase ac motor-generator of the permanent magnet type, Batt designates a battery and D designates a parasitic diode.

In the above-described conventional control circuit for the three-phase ac motor-generator, the current carrying control is conducted, as shown in FIG. 2, by turning on and off the gates of MOS field-effect transistors MOSFET 1 to 6 both on the positive and negative potential sides of respective phases under the control of a controller (not shown) when operating the motor-generator as a generator for charging the battery Batt.

The problems to be solved by the present invention are as follows:

The conventional control circuit of a three-phase ac motor generator, which can work both as a three-phase inverter circuit for driving a motor with power supply from a battery and a rectifier circuit for driving a generator for charging the battery and which uses MOS field-effect transistors as control elements for respective phases, has to perform the gate control of MOSFETs 1 to 6 both on the positive and negative sides of respective phases when driving the motor-generator for charging the battery. This complicates the control operation and, furthermore, decreases the battery charging efficiency because as the result of a large loss of rectification at parasitic diodes of MOSFETs 1 to 6 for respective phases.

### SUMMARY OF THE INVENTION

It is therefore a primary object of the present invention to provide a control device for a three-phase alternating-current motor-generator, which can work both as a three-phase inverter for driving the motor-generator as a three-phase ac generator by using a battery and as a three-phase rectifier for driving the motor-generator as a three-phase ac generator for generating power for charging the battery and which uses MOSFETs (Metal Oxide Silicone Field Effect Transistors) as control elements for each of three phases and which, in the case of operating the motor-generator for charging the battery, uses a means for performing synchronous rectification by using MOSFETs only on the negative potential side for respective phases in the control circuit so as to improve the battery charging efficiency by reducing the rectification loss and simplify the control operation.

### BRIEF DESCRIPTION OF THE DRAWINGS

FIG. 1 shows a control circuit of a three-phase alternating-current motor-generator, which has MOSFET control elements for each of three phases and which works as an inverter circuit when driving the motor-generator as a motor by using a battery and also works as a rectifier circuit when driving the motor-generator as a generator for charging the battery.

FIG. 2 is a timing chart for on-off control of the gates of MOSFETs both on the positive and negative potential sides of respective phases in the control circuit shown in FIG. 1 in accordance with an output voltage of a three-phase motor-generator when charging a battery.

FIG. 3 shows the flow of electric current when conducting the control of three-phase rectification by turning on and off the gates of MOSFETs only on the negative potential side of respective phases in the control circuit shown in FIG. 1 according to the present invention.

FIG. 4 shows a waveform (a) of three-phase rectification, a waveform (b) of a voltage between the drain D and the source S of each MOSFET and a waveform (c) of an induced voltage of each phase with respect to a neutral point represented by the phase U, which were obtained by turning on and off the gates of MOSFETs only on the negative potential side of the respective phases in the control circuit shown in FIG. 1 according to the present invention.

FIG. 5 shows a waveform (a) of three-phase, a waveform (b) of a voltage between the drain D and the source S of each MOSFET and a waveform (c) of an induced voltage of each phase with respect to a neutral point represented by the phase U, which were obtained by conducting the rectification by using parasitic diodes D keeping all MOSFETs on the positive and negative potential sides for respective phases as turned off in the control circuit of FIG. 1.

FIG. 6 shows an equivalent circuit when conducting three-phase rectification by using parasitic diodes keeping all MOSFETs on the positive and negative sides for respective phases as turned off in the control circuit of FIG. 1.

FIG. 7 shows characteristics of output voltage versus load current, which were obtained by conducting three-phase rectification by using MOSFETs only on the negative potential side of respective phases in the control circuit according to the present invention.

FIG. 8 shows current-to-power characteristics obtained by conducting three-phase rectification by using MOSFETs only on the negative potential side of respective phases in the control circuit according to the present invention.

FIG. 9 shows characteristics of battery charging efficiency versus load current, which were obtained by conducting three-phase rectification by using MOSFETs only on the negative potential side of respective phases in the control circuit according to the present invention.

FIG. 10 shows characteristics of rectification loss versus load current, which were obtained by conducting three-phase rectification by using MOSFETs only on the negative potential side of respective phases in the control circuit according to the present invention.

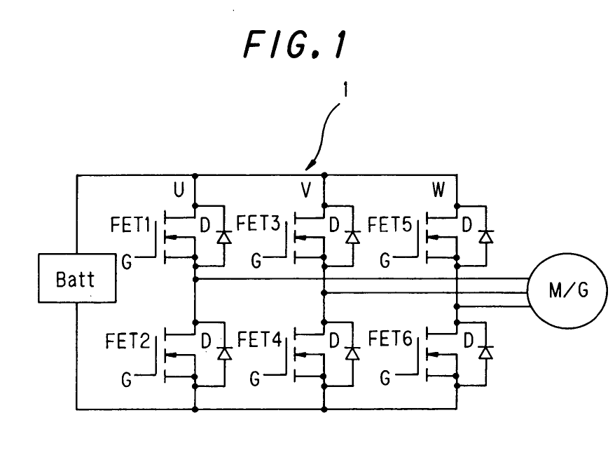

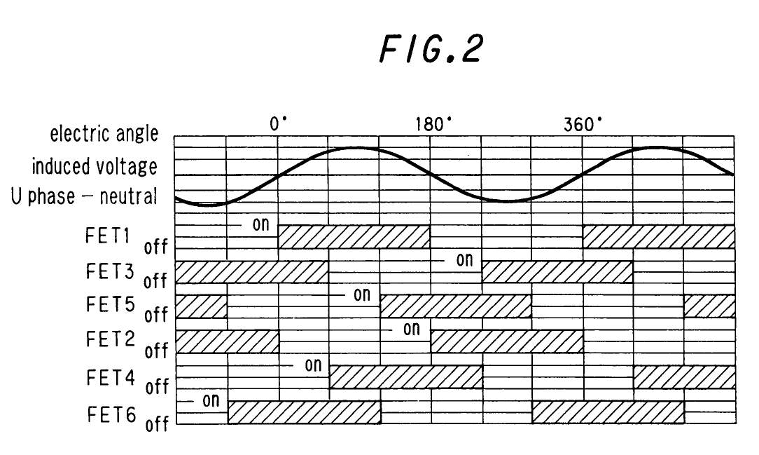

### PREFERRED EMBODIMENTS OF THE PRESENT INVENTION

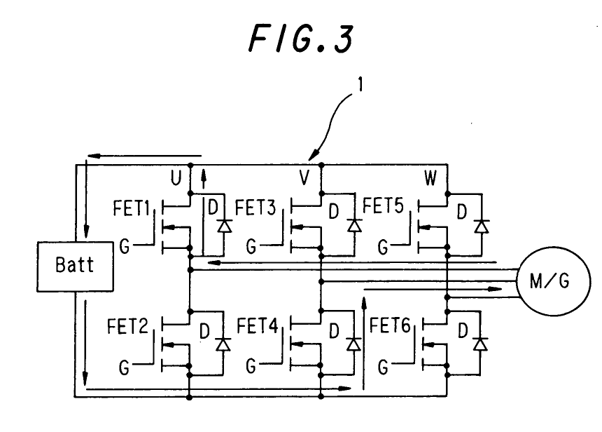

The control device of a three-phase alternating-current motor-generator according to the present invention includes a control circuit 1 as shown in FIG. 3, which can perform three-phase rectification by turning on and off the gates of only negative potential side MOSFET 2 (for U phase), MOSFET 4 (for V phase) and MOSFET 6 (for W phase) under the control of a controller (not shown) when driving the motor-generator MG as a three-phase alternating-current generator to produce output power for charging a battery Batt.

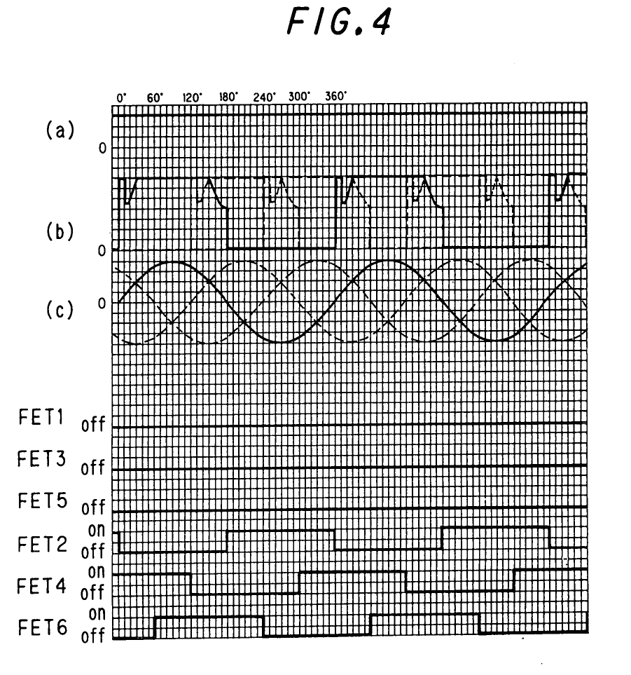

In FIG. 4, there is shown a waveform (a) of three phase rectification, a waveform (b) of a voltage between a drain D and a source S of each of MOSFETs 2, 4 and 6 and a waveform (c) of an induced voltage relative to a neutral point represented by the U phase, which were obtained in accordance with the ON and OFF states of each of MOSFETs 2, 4 and 6 on the negative potential side for each of three phases. In this case, all MOSFETs 1, 3 and 5 on the positive potential side for respective phases are always kept in the OFF state.

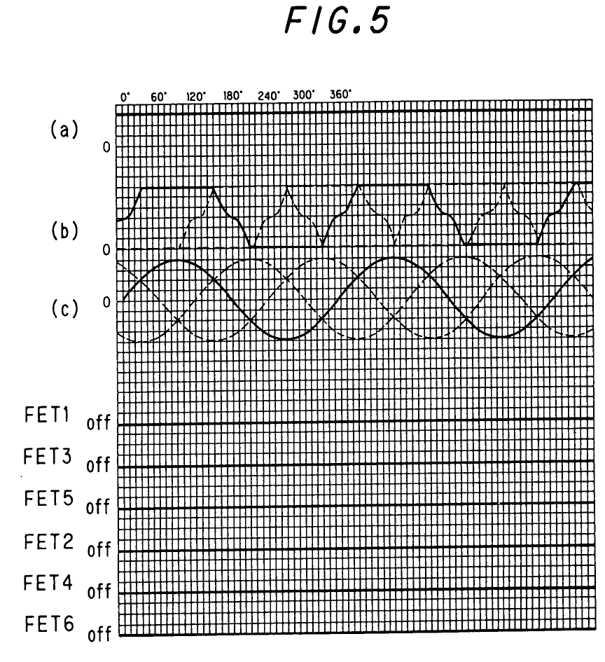

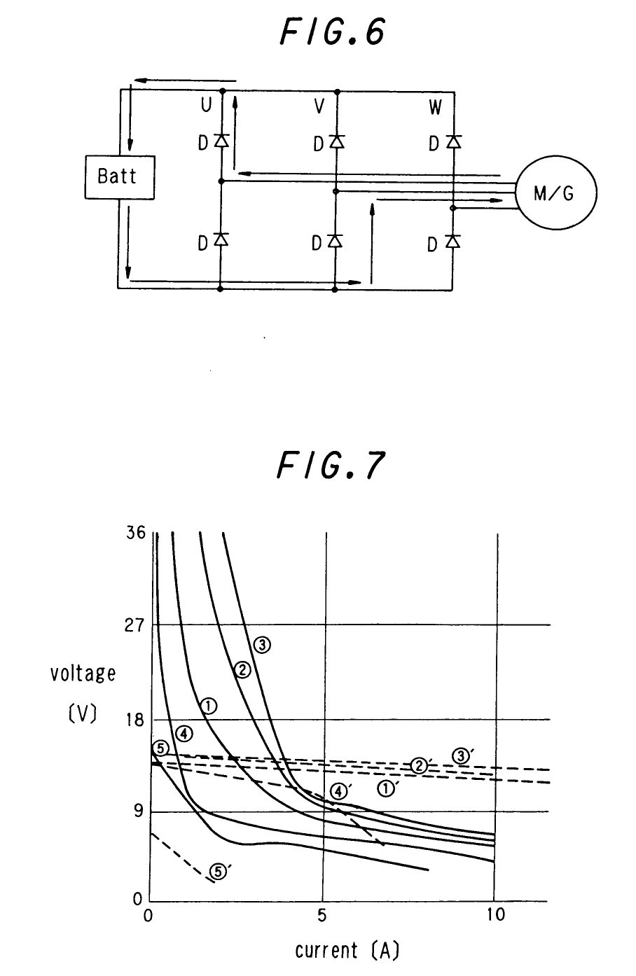

FIG. 5 shows a waveform (a) of three-phase rectification, a waveform (b) of a voltage between the drain D and the source S of each of MOSFETs 2, 4 and 6 and a waveform (c) of an induced voltage with a neutral point represented by the U phase when the rectification was made by using each parasitic diode D keeping all MOSFETs 1 to 6 on the positive and negative sides for respective phases as turned off. FIG. 6 shows an equivalent circuit of the control circuit 1 in that case.

According to the present invention, in the case of charging the battery Batt with a voltage produced by the three-phase alternating-current motor-generator MG, the synchronous rectification can be thus conducted by using merely MOSFETs 2, 4 and 6 on the negative potential side of respective phases U, V and W in the control circuit 1, thereby reducing the rectification loss and effectively increasing the efficiency of charging the battery Batt. As compared with the conventional control method that conducts ON-OFF control of all MOSFETs 1 to 6 both on the positive and negative potential sides of respective phases, the control device according to the present invention is simple and easy to operate.

In the case of charging the battery Batt with a voltage produced by the three-phase ac motor-generator MG, all MOSFETs 1, 3 and 5 on the positive potential side of respective phases U, V and W in the control circuit 1 are always kept as turned OFF, thereby preventing the motor-generator MG from erroneously operating in the motor mode.

FIG. 7 shows “output voltage versus load current” characteristics obtained by conducting three-phase rectification by using only MOSFETs 2, 4 and 6 on the negative potential side of respective phases in the control circuit according to the present invention. In FIG. 7, there is shown a characteristic (1) at a normal current-carrying control timing, characteristics (2), (3) at delayed current-carrying control timing and characteristics (4), (5) at advanced current-carrying control timing. In FIG. 7, characteristics shown by broken lines are “current-voltage” characteristics (1)′ to (5)′ obtained by conducting the rectification by using MOSFETs 1 to 6 both on the positive and negative potential sides for respective phases. Characteristics (1)′ to (5)′ respond respectively to the characteristics (1)′ to (5)′ obtained by conducting the rectification by using only MOSFETs 2, 4 6 on the negative potential side of respective phases.

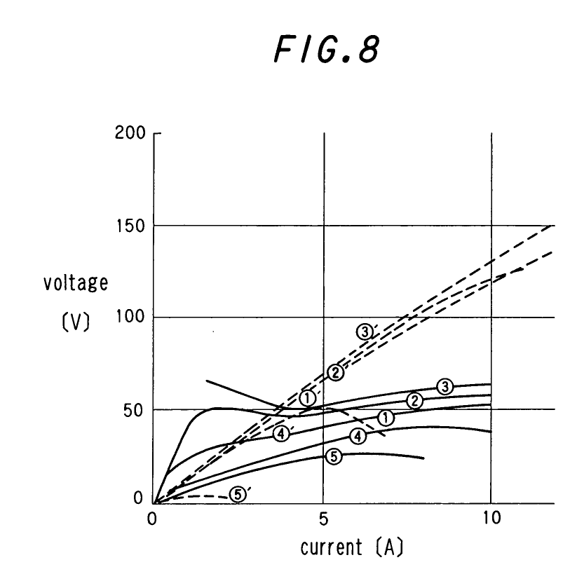

FIG. 8 shows current-to-power characteristics obtained by conducting three-phase rectification by using MOSFETs 2, 4 and 6 only on the negative potential side of respective phases in the control circuit 1 according to the present invention. In FIG. 8, characteristics shown by broken lines are current-voltage characteristics obtained by conducting the rectification by using MOSFETs 1 to 6 both on the positive and negative potential sides for respective phases.

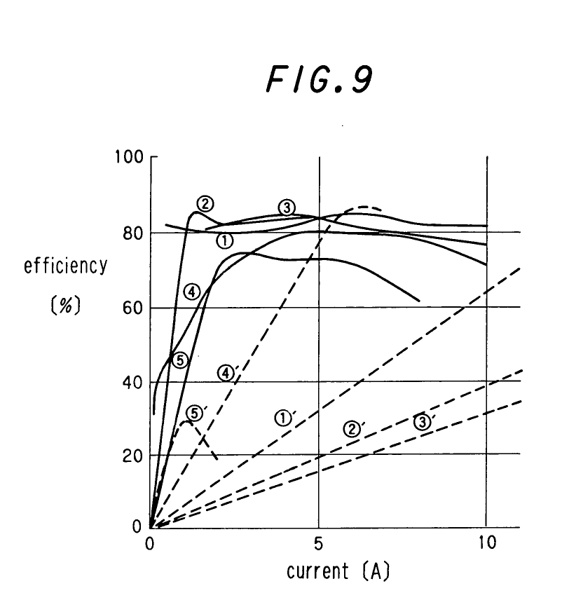

FIG. 9 shows characteristics of battery charging efficiency versus load current, which was determined by conducting three-phase rectification by using MOSFETs 2, 4 and 6 only on the negative potential side of respective phases in the control circuit 1 according to the present invention.

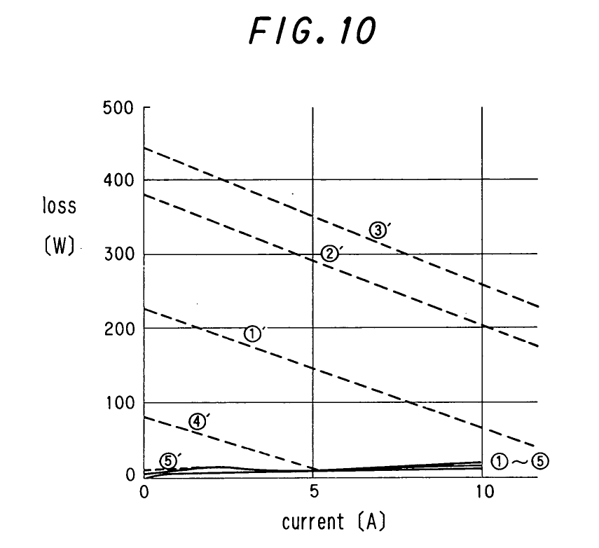

FIG. 10 shows characteristics of rectification loss versus load current, which was obtained by conducting three-phase rectification by using MOSFETs 2, 4 and 6 only on the negative potential side of respective phases in the control circuit 1 according to the present invention. The characteristics indicate that the rectification loss can be effectively reduced according to the present invention.

As is apparent from the foregoing, the control device according to the present invention includes a control circuit of a three-phase alternating-current motor-generator, which uses MOSFETs as control elements for respective phases and can operate both as a three-phase inverter for driving the three-phase ac motor and a three-phase rectifier for driving the three-phase ac generator to charge a battery. This control device has a means for conducting the three-phase rectification by using MOSFETs only on the negative potential side of respective phases in the control circuit. The control device offers the advantage of effectively reducing the battery charge loss and easily performing the control operation.

1. a control device for a three-phase alternating-current motor-generator, which is capable of working as a three-phase inverter circuit for driving the motor-generator as a three-phase alternating-current motor by using a battery and also working as a three-phase rectifier circuit for driving the motor-generator as a three-phase alternating-current generator for generating electric power for charging the battery and which uses mosfets as control elements for each of the phases, wherein, when driving the motor-generator as the three-phase alternating-current generator, the control device uses means for performing synchronous rectification by using mosfets only on the negative potential side of the respective phases.
